(19) United States
(12) Patent Application Publication
(10) Pub. No.: US 2026/0239353 A1
(43) Pub. Date: Aug. 13, 2026

(54) METHOD, DEVICE, AND SYSTEM FOR UCI AND PUCCH MAPPING IN WIRELESS NETWORKS

(71) Applicant: ZTE CORPORATION, Shenzhen, Guangdong (CN)

(72) Inventors: Xiangyang DUAN, Shenzhen (CN); Hanchao LIU, Shenzhen (CN); Feng XIE, Shenzhen (CN); Fei WANG, Shenzhen (CN)

(21) Appl. No.: 19/154,597

(22) PCT Filed: Feb. 8, 2023
(86) PCT No.: PCT/CN2023/075073

§ 371 Date: Aug. 7, 2025

(51) Int. Cl. H04W 72/21; H04L 5/00

(52) U.S. Cl. CPC H04W 72/21; H04L 5/0044

(57) ABSTRACT

This disclosure relates generally to a method, device, and system for mapping, and transmission of UCI in a wireless network. One method performed by a wireless device is disclosed. The method may include: receiving, from a network node, a UCI mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and transmitting a first set of UCIs in the PUCCH based on the UCI mapping information, wherein a RAT of at least one UCI in the first set of UCIs is different from the first RAT.

### TECHNICAL FIELD

This disclosure is directed generally to wireless communications, and particularly to a method, device, and system for mapping, and transmission of Uplink Control Information (UCI) in a wireless network.

### BACKGROUND

With the rapid evolution of wireless communication technology, and to satisfy the demand for higher speed, higher throughput and capacity, higher efficiency, and lower latency, new Radio Access Technologies (RATs) are emerging and commercialized rapidly. This may be represented by newer generation of wireless technologies. At the same time, the previous generation of RATs may still be employed to generate return on the investment as they still have the ability to undertake communication tasks and carry significant amount of traffic. It is critical to effectively utilize radio resources of different RATs in the wireless network.

### SUMMARY

This disclosure is directed to a method, device, and system for mapping, and transmission of UCI in a wireless network.

In some embodiments, a method performed by a wireless device is disclosed. The method may include: receiving, from a network node, an Uplink Control Information (UCI) mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and transmitting a first set of UCIs in the PUCCH based on the UCI mapping information, wherein a RAT of at least one UCI in the first set of UCIs is different from the first RAT.

In some embodiments, a method performed by a network node is disclosed. The method may include: transmitting, to a wireless device, an Uplink Control Information (UCI) mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and receiving, from the wireless device, a first set of UCIs in the PUCCH based on the UCI mapping information, wherein a RAT of at least one UCI in the first set of UCIs is different from the first RAT.

In some embodiments, there is a wireless device or a network node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary dual connectivity configuration with one 4G connection and one 5G connection.

FIG. 5a shows an exemplary cross-RAT UCI mapping under a dual connectivity configuration with one 4G connection and one 5G connection.

FIG. 5b shows an exemplary cross-RAT UCI mapping under a tiple connectivity configuration with one 3G connection, one 4G connection, and one 5G connection.

FIG. 6 shows an exemplary Multi-RAT Dual connectivity configuration.

FIG. 7 shows an exemplary Inter-RAT Carrier Aggregation (Inter-RAT CA) configuration.

FIGS. 8a-8d show exemplary UCI ordering schemes when mapping UCIs to PUCCH.

FIG. 9 shows an exemplary method 900 for wireless communication.

### DETAILED DESCRIPTION

### Wireless Communication Network

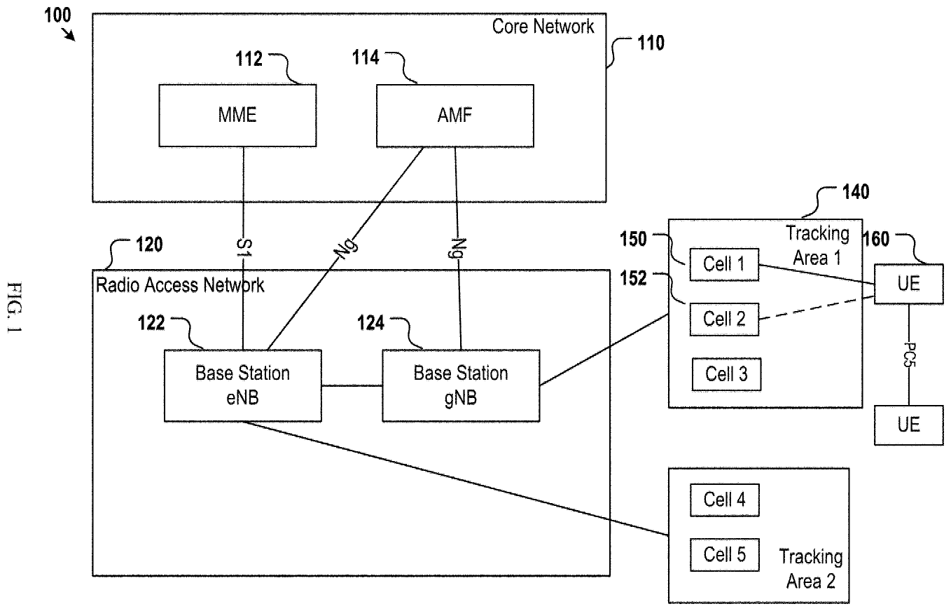

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

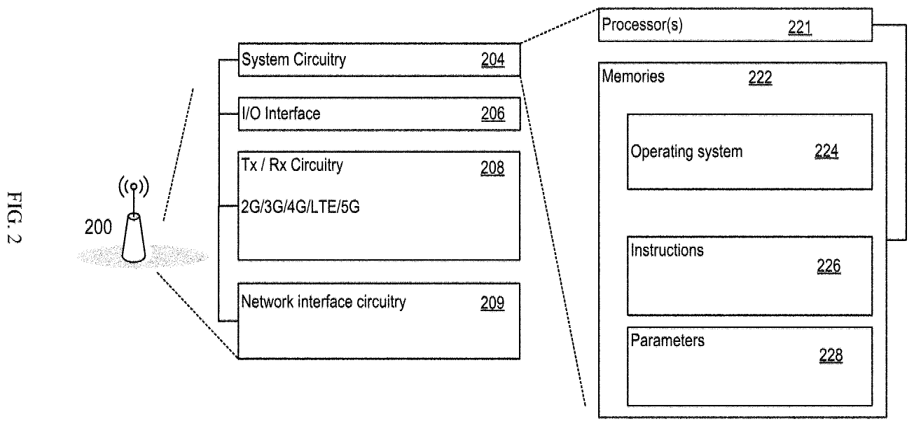

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

Network Deployment with Multiple RAT

With the rapid evolution of wireless communication technology, and to satisfy the demand for higher speed, higher throughput and capacity, higher efficiency, and lower latency, new Radio Access Technologies (RATs) are emerging and commercialized rapidly. This may be represented by newer generation of wireless technologies. At the same time, the previous generation of RATs may still be employed to generate return on the investment as they still have the ability to undertake communication tasks and carry significant amount of traffic. For example, in the initial stage of 5th generation (5G) mobile network deployment, a Non-Standalone (NSA) Architecture may be adopted. Under an example NSA architecture, an existing 4G core is used as an anchor point for the control signaling of a 5G Radio Access Network (RAN). That is, the 5G RAN is overlaid in an existing 4G core.

Multi-RAT networking has become an important networking scenario for wireless communications. For example, more RATs will participate in collaborative networking, and the networking scenarios will be more complex. In addition to Multi-RAT Dual connectivity (MRDC), there may be more other multi-RAT networking solutions in the development stage of mobile communication in the future, such as inter-RAT Carrier Aggregation (CA). Therefore, how to efficiently use different RAT resources is an issue that requires great attention now and in the future.

In wireless communication technology such as 5G technology, multiple different RATs may be deployed together to form a multi-RAT network. This type of deployment may also be referred to as a multi-RAT collaborative network. In general, a RAT defines underlying physical connection method, protocol, and specification for a radio-based communication network. The RAT may include cellular wireless technology in various generation, such as 5G New Radio (NR), 4G Long Term Evolution (LTE), Evolved UMTS Terrestrial Radio Access Network (E-UTRAN), Worldwide Interoperability for Microwave Access (WiMax), 3G Universal Mobile Telecommunications System (UMTS), 3G Code Division Multiple Access (CDMA), 2G Global System for Mobile Communications (GSM), etc. The RATs may further include non-cellular technologies, such as Wi-Fi, ZigBee, LoRa, Bluetooth, and the like.

In the multi-RAT network, connections may be established between the UE and the network based on two or more links using different RATs. In example implementations, each RAT link may connect to or terminate on a different network node (or network element, such as a base station) that is RAT specific. In other example implementations, each RAT link may connect to or terminate on a same network node that is capable of supporting multiple RATs. Each RAT link may have a Physical Uplink Control Channel (PUCCH) which carries the Uplink Control Information (UCI) specific to the RAT associated with the link. The UE may send/transmit UCIs of different RATs on these uplink PUCCHs. Specifically, due to different underlying technical specifications of the RATs (e.g., physical layer specifications), the UE may need to process and transmit these UCIs following their corresponding RATs. More details will be described in sections below.

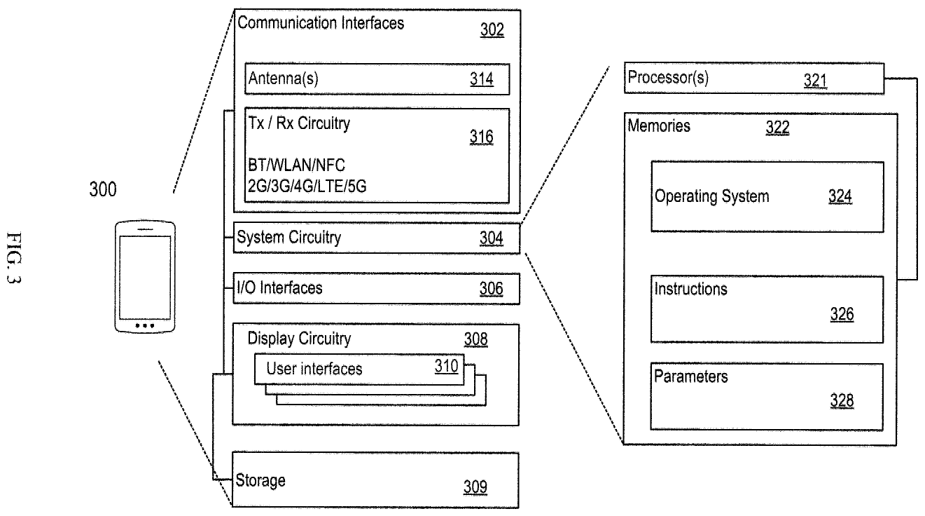

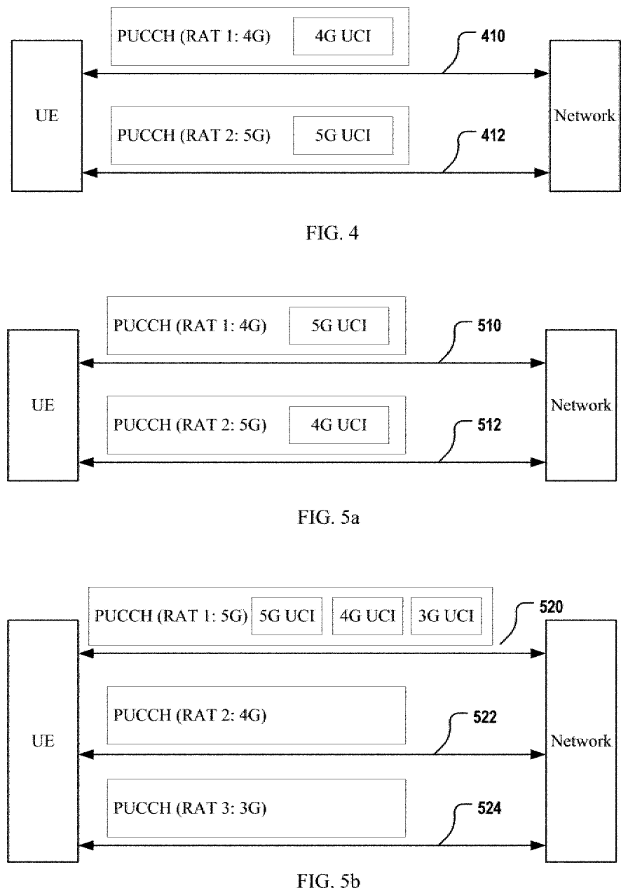

FIG. 4 shows an exemplary multi-RAT network deployment scenario. In FIG. 4, two connections (links) are established between the UE and the network. Link 410 uses 4G RAT (or belongs to 4G RAT), and link 412 uses 5G RAT. The 4G and 5G RATs in this example are for exemplary purpose only. Alternatively and/or additionally, there may be links belonging to other RATs. Note that the network may include a Radio Access Network (RAN), which may include, for example, base stations of various generations of technologies. These base stations may terminate the links with the UE. In some implementations, each base station may correspond to a particular RAT. In some other implementations, one base station may support multiple RATs simultaneously.

The multi-RAT network deployment may include various scenarios, such as Multi-RAT Dual Connectivity (MRDC), and Inter-RAT CA. MRDC refers to a range of different Dual Connectivity configuration options. In example implementations, under MR-DC, a Master RAN Node functions as the controlling entity, utilizing a Secondary RAN for additional data capacity. Example MR-DC configurations include EN-DC (E-UTRA-NR Dual Connectivity), NE-DC (NR-E-UTRA Dual Connectivity), NR-DC (New Radio Dual Connectivity), NGEN-DC (NG-RAN-E-UTRA Dual Connectivity), etc. Under Inter-RAT CA, multiple connections between UE and network may be established using multiple carriers belonging to different RATs. For example, these carriers may belong to a Primary cell (Pcell) and Secondary cells (Scells) using different RATs; or these carriers may belong to Scells using different RATs.

In some example implementations, the multi-RAT collaborative networks may be formed by 4G E-UTRAN and 5G NR. In particular, as the uplink and downlink waveform format for 4G E-UTRAN and 5G NR are both based on Orthogonal Frequency Division Multiplexing (OFDM) and Single-Carrier FDMA (SC-FDMA), there is special benefit for collaborative networking between the two.

In order to support uplink and downlink data transmission, in wireless communication, such as cellular mobile communication, various uplink control signaling and uplink physical control channels are provided. For example, in 4G E-UTRAN and 5G, a Physical Uplink Control Channel (PUCCH) is defined. There are various PUCCH formats. For example, in 4G LTE, there are PUCCH format 1/1a/1b, PUCCH format 2/2a/2b, PUCCH format 1b with channel selection, PUCCH format 3, etc. In 5G NR, there are PUCCH formats 0/1/2/3/4.

In example implementations, the PUCCH may be used for transmitting Uplink Control Information (UCI). The UCI may be mapped to and carried in the PUCCH for transmission. Specifically, the UCI may be used for:
Scheduling Request (SR): requesting resource, such as uplink shared channel (UL-SCH), from the network.
Hybrid Automatic Repeat Request (HARQ) Acknowledgement/Non-Acknowledgement (ACK/NACK): indicating positive acknowledgement (ACK) or negative acknowledgement (NACK) for downlink data.
Channel State Information (CSI): enabling the network to obtain downlink channel quality; assisting downlink scheduling, downlink beamforming, downlink precoding, etc.

Each RAT may have its corresponding UCIs and UCIs may be categorized by the corresponding RATs. For example, there may exist: UCIs for 5G NR RAT (i.e., 5G NR RAT UCIs, or 5G RAT UCIs); UCIs for 4G LTE (i.e., 4G LTE RAT UCIs, or 4G RAT UCIs); UCIs for 3G UMTS (i.e., 3G UMTS RAT UCIs; UCIs for Wi-Fi (i.e., Wi-Fi RAT UCIs, or 3G RAT UCIs); UCIs for Bluetooth (i.e., Bluetooth RAT UCIs), and the like. Each type of UCI corresponds to and is used to support its corresponding RAT. In this disclosure, a UCI for a RAT may be referred to as UCI belonging to the RAT. A UCI may carry control information for a cell. That is, a UCI may target, apply to, or belong to a cell if the UCI carries control information for the cell.

In existing mobile communication technology, the UCI for a RAT can only be carried in the PUCCH of the same RAT for transmission. That is, the RAT of the UCI and the RAT of the PUCCH need to match. For example, a UCI for 4G LTE (i.e., a 4G LTE RAT UCI) can only be carried in the PUCCH of 4G LTE RAT for transmission; a UCI for 5G NR can only be carried in the PUCCH of the 5G NR RAT for transmission. Although the UCI for one carrier may be carried in the PUCCH of another carrier for transmission, that is, the UCI transmission is cross-carrier, these two carriers still belong to the same RAT. For example, the PUCCH of a 5G NR Primary cell (Pcell) may carry a UCI for the 5G NR Secondary cell (Scell), however, the UCI RAT of the UCI (or RAT of the UCI for simplicity) is still 5G NR, that is, the RAT of the UCI and the RAT of the PUCCH are still the same.

In existing mobile communication technology, in a multi-RAT network deployment scenario, two or more different RAT links may be established between the UE and the network, and each RAT link may include a corresponding PUCCH of the same RAT. The UCI for each RAT can only be carried in the PUCCH of the same RAT for transmission. For example, as shown in FIG. 4, a 4G link 410 and a 5G link 412 are established between the UE and the network. Exemplarily, in this disclosure, a link between the UE and the network may be bi-directional and may include a PUCCH (for uplink) and a PDCCH (for downlink). The UCI for 4G RAT (4G UCI) can only be carried in the PUCCH of a same 4G RAT for transmission; whereas the UCI for 5G NR (5G NR UCI) can only be carried in the PUCCH of the same 5G NR RAT for transmission. Note that the network may include a Radio Access Network (RAN), which may include, for example, base stations of various generations of technologies. These base stations may terminate the links with the UE.

It is observed that each RAT may have its own corresponding frequency point and the frequency points for these RATs are different. An uplink with a higher frequency point tends to have limited or smaller coverage compared with an uplink with a lower frequency point. At a high frequency, the path loss is large, and so is the energy attenuation of the electromagnetic wave during the air interface propagation process, resulting in weak signal strength received by the network. This leads to a low Signal to Interference and Noise Ratio (SINR) at the network, and may seriously impact the signal demodulation on the network. When the channel quality of one or more uplink RAT links is degraded, the network may not be able to receive (e.g., demodulate, decode) the UCIs for the corresponding RATs correctly, causing degradation and/or interruption of data transmission.

In order to solve the aforementioned problems, in this disclosure, various cross-RAT UCI mapping methods are disclosed, such that UCI for one RAT (UCI belonging to one RAT) may be mapped to a PUCCH of a different RAT for transmission. The methods are discussed in great details in sections below.

### Cross-RAT UCI Mapping and Transmission

Referring to FIG. 5a, in a multi-RAT network deployment scenario, two or more connections, also referred to as RAT links (e.g., 510 and 512), may be established between the UE and the network. The UCI for one RAT may be mapped to and carried in the PUCCH of one or more other RATs for transmission. For example, link 510 uses 4G RAT, and link 512 uses 5G RAT. A UCI for 5G NR (5G UCI) can be mapped to and carried in the PUCCH of the 4G link 510 for transmission. Similarly, a UCI for 4G (4G UCI) can be mapped to and carried in the PUCCH of the 5G NR link 512 for transmission.

As another example, link of other RAT, such as a link of 3G UMTS may also exist. As shown in FIG. 5b, there are 3 RAT links: a 5G RAT link 520, a 4G RAT link 522, and a 3G RAT link 524. Exemplarily, UCIs for all the RATs (5G, 4G, and 3G UCIs) are mapped to and carried in the PUCCH of the 5G link 520 for transmission.

In example implementations, when the channel quality of one or more uplink RAT links (but not all RAT links) between the UE and the network is degraded (e.g., SINR is below a threshold), the UCIs for these RATs may be carried in the PUCCH(s) of other RAT(s) for transmission, for example, if channel quality of these PUCCHs is good (e.g., channel quality is above a threshold). For example, referring back to FIG. 5b, when the 3G and 4G uplink channel quality are degraded and the 5G uplink channel quality is good, the 3G UCIs and 4G UCIs may be mapped to and carried in the 5G PUCCH for transmission. For another example, when the 4G uplink channel quality is poor and the 5G uplink channel quality is good, the 4G UCI can be mapped to and carried in the 5G PUCCH for transmission.

In this disclosure, various embodiments are described, aiming for at least solving the technical issue of UCI transmission failure due to degraded channel quality in a multi-RAT collaborative networking environment. These embodiments may utilize cross-RAT UCI mapping, that is, UCI for one RAT (or UCI belonging to one RAT) may be mapped to and transmitted in a PUCCH of a different RAT. In some example implementations, a scope may be applied to the UCIs. The scope may include at least one cell, at least one cell group, and the like. For example, when the scope is “at least one cell”, then UCIs for one RAT and belonging to the at least one cell may be transmitted in a PUCCH of a different RAT.

In this disclosure, for ease of description, UCI RAT is used to refer to a RAT to which the UCI applies or belongs to. For example, 5G RAT UCI (or 5G UCI for short) refers to the UCI applicable to 5G RAT. Similarly, PUCCH RAT is used to refer to a RAT to which the PUCCH belongs, or a RAT the PUCCH uses. For example, there may be 3G PUCCH for a PUCCH belonging to 3G, 4G PUCCH for a PUCCH belonging to 4G, and 5G PUCCH for a PUCCH belonging to 5G.

Details on these embodiments are described below.

### Embodiment 1: Cross-RAT UCI Mapping in MRDC

In a wireless communication network, an MRDC (Multi-RAT Dual Connectivity) networking may be employed.

In example implementations, a UE may be configured with a Master Cell Group (MCG) and a Secondary Cell Group (SCG). The MCG and the SCG belong to different RATs.

The MRDC may include following configurations:
EN-DC (E-UTRA-NR Dual Connectivity)
NR-DC (New Radio Dual Connectivity)
NGEN-DC (NG-E-UTRA-NR Dual Connectivity)
NE-DC (NR-E-UTRA Dual Connectivity)

The MCG may include a group of serving cells associated with the Master Node, including a Pcell and optionally one or more Scells. The SCG may include a group of serving cells associated with the Secondary Node, including a Primary SCG Cell (PScell) and optionally one or more Scells.

The MCG and the SCG may each have its own UCI (e.g., MCG UCI or SCG UCI). In this embodiment, the MCG UCI may be carried in the PUCCH of the SCG, for example, the PUCCH of PScell or Scell of the SCG. Similarly, the SCG UCI may be carried in the PUCCH of the MCG, for example, the PUCCH of Pcell or Scell of the MCG.

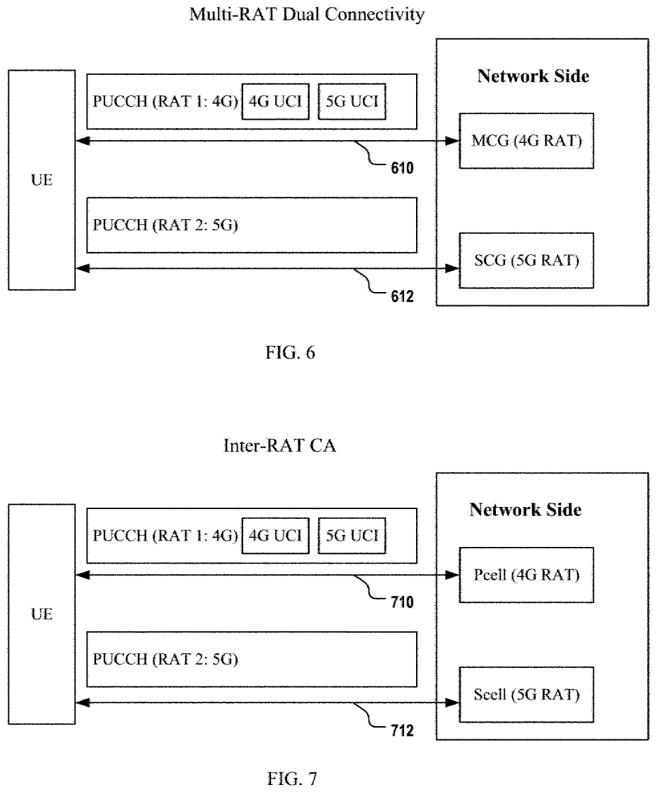

Referring to FIG. 6 for an exemplary MRDC deployment. In FIG. 6, the UE has dual connections (610 and 612) with the network. Specifically, UE is configured with connection 610 with the MCG (4G RAT) and connection 612 with the SCG (5G RAT).

An exemplary method according to this embodiment may include following steps:

### Step 1:

The UE receives configuration information from the network (or network side). The configuration information may include cross-RAT UCI mapping information indicating that UCIs for one or more RATs are mapped to and transmitted in a PUCCH of another RAT.

In one implementation, UE may receive the configuration information from a network node in the network, such as a base station.

For example, under the MRDC, the cross-RAT UCI mapping information may include UCI RATs for UCIs that are assigned to be transmitted in a corresponding PUCCH (i.e., UCIs to be mapped to a PUCCH), as well as the PUCCH RAT for the corresponding PUCCH. Refer to Table 1 below for some exemplary cross-RAT UCI mapping information. In Table 1, each row represents a possible cross-RAT UCI mapping information.

TABLE 1
Cross-RAT UCI Mapping to PUCCH

| | PUCCH | |
|---|---|---|
| UCI RATs | RAT | Note |
| {3G, 4G, 5G} | 5G | UCIs with UCI RATs belonging to {3G, 4G, |
| | | 5G} are mapped to and carried in a PUCCH |
| | | using 5G RAT. |
| {4G, 5G} | 4G | UCIs with UCI RATs belonging to {4G, 5G} |
| | | are mapped to and carried in a PUCCH using |
| | | 4G RAT. |

Note that in Table 1, UCI RAT is indicated explicitly. Alternatively, other information may be used to implicitly indicate one or more UCI RATs. In some example implementations, there is a mapping relationship between a cell and a RAT (i.e., the cell uses or belong to the specific RAT). A cell identifier (ID) may be employed to implicitly indicate the UCI RAT. For example, a cell with cell ID 100 is a 4G cell, and a cell with cell ID 200 is a 5G cell, then instead of using {4G, 5G} to represent the UCI RATs, {cell ID 100, cell ID 200} may be used. Further note that by using a cell ID, such as cell ID 100, a further restriction may be added, such that only UCIs belong to cell ID 100 is to be mapped. In some other example implementations, a UCI RAT may be represented by using a combination of RAT and a cell identifier. For example, the UCI RATs may be indicated as: {(3G, cell ID 100), (4G, cell ID 200)}. Under this representation, 3G UCIs belong to cell ID 100, and 4G UCIs belong to cell ID 200 are to be mapped.

Note that in Table 1, PUCCH RAT is indicated explicitly in the cross-RAT UCI mapping information. Alternatively, other information may be used to implicitly indicate PUCCH of a certain RAT. In some example implementations, a cell group (e.g., MCG, or SCG, see further details below) may be used. Based on such information, the UE may be able to determine the particular PUCCH among multiple PUCCHs, and use the particular PUCCH to receive UCIs mapped therein. In some example implementations, a cell ID may be used to indicate the PUCCH (and its RAT) associated with the cell identified by the cell ID.

For another example, under the MRDC, the cross-RAT UCI mapping information may include cell group(s) for UCIs that are assigned to be transmitted in a corresponding PUCCH, as well as the PUCCH RAT (or PUCCH cell group) for the corresponding PUCCH. Refer to Table 2 below for some exemplary cross-RAT UCI mapping information. Exemplarily, the RATs of the MCG and the SCG are 5G and 4G, respectively. In Table 2, each row represents a possible cross-RAT UCI mapping information.

TABLE 2
Cross-RAT UCI Mapping to PUCCH

| Cell Group | Cell Group | |
|---|---|---|
| of UCI | of PUCCH | Note |
| {MCG, SCG} | SCG | UCIs for cell group {MCG, SCG} are |
| | | carried in a PUCCH of the SCG. |
| {MCG} | SCG | UCIs for cell group {MCG} are carried |
| | | in a PUCCH of the SCG. |
| {SCG} | MCG | UCIs for cell group {SCG} are carried |
| | | in a PUCCH of the MCG. |

The configuration information may be sent from the network to the UE via, for example, a Radio Resource Control (RRC) message, a System Information message, and the like. Exemplarily, the configuration information may be carried in an Information Element (IE) of the RRC message, such as a PUCCH configuration IE (PUCCH-Config IE), PUCCH configuration common IE (PUCCH-ConfigCommon IE), and the like.

The RRC message may include: an RRCReconfiguration message; an RRCSetup message, and an RRCResume message.

A UE may receive the configuration information when it is in various states. For example, a UE in idle state may receive the configuration information via an RRCSetup message when the UE attempts to access/connect to the Master Node (MN) in the MCG; a UE in inactive state may receive the configuration information via an RRCResume message when the UE is woken up by the Master Node; a UE in connected state may receive the configuration information via an RRCReconfiguration message when certain configuration, such as Master Node configuration, is re-configured; a UE may receive the configuration information via an RRCReconfiguration message when adding a Secondary Node (SN, corresponding to SCG).

Referring to FIG. 6, the UE may receive configuration information indicating that UCI belonging to 4G RAT and UCI belonging to 5G RAT are mapping into and carried in a 4G PUCCH. Note that the 4G PUCCH is supported by the MCG via link 610. Further note that in this scenario, the 5G PUCCH supported by the SCG via link 612 does not carry any UCI.

Aforementioned cross-RAT UCI mapping information is only for exemplary purpose. Note that the cross-RAT UCI mapping information may be presented in various forms not explicitly described above, as far as the UE may determine the UCI to PUCCH mapping, or more specifically, UCI RATs to PUCCH mapping. For example, the mapping of UCI RATs to PUCCH of a certain RAT, or the mapping of UCI RATs to PUCCH of a certain cell/cell group, etc. Exemplarily, further restriction may be imposed, such that in the mapping relationship, the UCI RATs may apply to UCIs belonging to one or more cells, or UCIs belonging to one or more cell groups.

In some example implementations, multiple set of configuration information may be defined and configured to the UE. Further, the network may activate or enable one of the set via signaling.

### Step 2:

UE sends UCIs belonging to various RATs (e.g., 3G, 4G, and 5G) or various cell groups (e.g., MCG, or SCG) from a designated PUCCH based on the configuration information received in step 1.

Based on the configuration information, the UE may determine the UCI to PUCCH mapping information.

In some example implementations, UE may determine UCIs belonging to certain cell groups, or belonging to certain RATs are mapped to a PUCCH of a particular cell group or a particular RAT.

As an example, UE may determine that UCIs belonging to SCG are mapped into and carried in a PUCCH of the MCG. If the RAT of the MCG is 5G and the RAT of the SCG is 4G, then the UE will send 4G UCIs on the 5G PUCCH supported by the MCG.

As another example, UE may determine that UCIs belonging to any one of MCG and SCG are mapped into and carried in a PUCCH of the SCG. If the RAT of the MCG is 5G and the RAT of the SCG is 4G, then the UE will send 4G UCIs and 5G UCIs on the 4G PUCCH supported by the SCG.

As another example, UE may determine that UCIs belonging to 4G RAT are mapped into and carried in a PUCCH of the 5G RAT. If the RAT of the MCG is 5G and the RAT of the SCG is 4G, then the UE will send 4G UCIs on the 5G PUCCH supported by the MCG.

As another example, UE may determine that UCIs belonging to any one of 4G RAT and 5G RAT are mapped into and carried in a PUCCH of the 4G RAT. If the RAT of the MCG is 5G and the RAT of the SCG is 4G, then the UE will send 4G UCIs and 5G UCIs on the 4G PUCCH supported by the SCG.

As another example, UE may determine that UCIs belonging to cell with cell ID 100 (3G RAT) is mapped to a 4G PUCCH; or UE may determine that UCIs belonging to one cell with cell ID 100 (e.g., a 3G cell) is mapped to a 4G PUCCH in another cell with cell ID 200 (e.g., a 4G cell).

Note that the UE transmits (which may include encoding) the PUCCH following specification of the RAT to which the PUCCH belongs to, even though UCIs carried in the PUCCH may belong to RATs different from the PUCCH RAT.

In some example implementations, the UE may encode each UCI carried in the PUCCH based on the RAT of the each UCI (i.e., following the specification of the respective RAT). For example, if a PUCCH carries UCIs for 4G and 5G, then the UE may encode the 4G UCIs and 5G UCIs in accordance with the 4G RAT specification and 5G RAT specification, respectively.

### Embodiment 2: Cross-RAT UCI Mapping in Inter-RAT CA

In a wireless communication network, an Inter-RAT Carrier Aggregation (inter-RAT CA) networking may be employed.

Under the Inter-RAT CA, a UE may be configured with one Pcell and one or more Scells. Within component carriers (used for carrier aggregation), there are carriers belonging to different RATs. For example, the Pcell and the one or more Scell may correspond to different RATs; or one Scell and another Scell may correspond to different RATs.

In some example implementations, the Pcell may have its own UCI (Pcell UCI). The Pcell UCI belongs to the same RAT as the Pcell. On the Scell side, there may exist multiple scenarios. In one scenario, all the Scells share Scell UCIs, that is, Scell UCIs may apply to all the Scells. In another scenario, each Scell has its own Scell UCI. Scell UCIs belong to or apply to the same RAT as the Scell(s) they apply to.

Referring to FIG. 7 for an exemplary Inter-RAT CA networking. In FIG. 7, the UE has dual connections (710 and 712) with the network. Specifically, UE is configured with connection 710 with the Pcell (4G RAT) and connection 712 with the Scell (5G RAT).

In this embodiment, UE sends a PUCCH of the Pcell or a Scell, and the PUCCH may carry UCIs belonging to different RAT. That is, UCIs for multiples cells (Pcells and/or Scells) and belonging to different RATs may be mapped into and carried in a same PUCCH. As an example, in FIG. 7, the PUCCH supported by the Pcell (4G RAT) carries UCIs for both the Pcell and the Scell, that is, the 4G PUCCH carries the 4G UCIs and 5G UCIs. An exemplary method according to this embodiment may include following steps:

### Step 1:

The UE receives configuration information (or more specifically, cross-RAT UCI mapping configuration information) from the network. The configuration information may include cross-RAT UCI mapping information indicating that UCIs for one or more cells belonging to one or more RATs are mapped to and transmitted in a PUCCH of another cell belong to a RAT different from the one or more RATs.

In one implementation, UE may receive the configuration information from a network node in the network, such as a base station.

For example, under the Inter-RAT CA configuration, the cross-RAT UCI mapping information may include UCI RATs for UCIs that are assigned to be transmitted in a corresponding PUCCH, as well as the PUCCH RAT for the corresponding PUCCH. Refer to Table 3 below for some exemplary cross-RAT UCI mapping information. In Table 3, each row represents a possible cross-RAT UCI mapping information.

TABLE 3
Cross-RAT UCI Mapping to PUCCH RAT

| UCI | PUCCH | |
|---|---|---|
| RATs | RAT | Note |
| {3G, 4G, | 5G (Pcell) | UCIs with UCI RATs belonging to {3G, 4G, |
| 5G} | | 5G} are carried in a PUCCH of the Pcell |
| | | using 5G RAT. |
| {4G, 5G} | 4G (Scell) | UCIs with UCI RATs belonging to {4G, 5G} |
| | | are carried in a PUCCH of the Scell using 4G |
| | | RAT. Further note that an Scell ID may also |
| | | be included in the configuration information. |

Note that in Table 3, UCI RAT is indicated explicitly. Alternatively, other information may be used to implicitly indicate one or more UCI RATs. In some example implementations, there is a mapping relationship between a cell and a RAT (i.e., the cell uses or belong to the specific RAT). A cell identifier may be employed to implicitly indicate the UCI RAT. For example, a cell with cell ID 100 is a 4G cell, and a cell with cell ID 200 is a 5G cell, then instead of using {4G, 5G} to represent the UCI RATs, {cell ID 100, cell ID 200} may be used. Further note that by using a cell ID, such as cell ID 100, a further restriction may be added, such that only UCIs belong to cell ID 100 is to be mapped. In some other example implementations, a UCI RAT may be represented by using a combination of a RAT and a cell identifier. For example, the UCI RATs may be indicated as: {(3G, cell ID 100), (4G, cell ID 200)}. Under this representation, 3G UCIs belong to cell ID 100, and 4G UCIs belong to cell ID 200 are to be mapped.

Note that in Table 3, PUCCH RAT is indicated explicitly in the cross-RAT UCI mapping information. Alternatively, other information may be used to indirectly indicate PUCCH of a certain RAT. In some example implementations, a cell identifier identifying, for example, a Pcell, an Scell, or a PScell, may be used. Based on such information, the UE may be able to determine the particular PUCCH among multiple PUCCHs, and use the particular PUCCH to send UCIs mapped therein.

For another example, under the Inter-RAT CA configuration, the cross-RAT UCI mapping information may include cell(s) (or identifier(s) for cell(s)) for UCIs that are assigned to be transmitted in a corresponding PUCCH, as well as the PUCCH RAT (or cell identity) for the corresponding PUCCH. Refer to Table 4 below for some exemplary cross-RAT UCI mapping information. Exemplarily, the RATs of the Pcell is 5G and the Scells are 5G or 4G, respectively. In Table 4, each row represents a possible cross-RAT UCI mapping information.

TABLE 4
Cross-RAT UCI Mapping to PUCCH RAT or Cell Identity

| | PUCCH RAT (or | |
|---|---|---|
| Cell Group of UCI | Cell Identity) | Note |
| {Pcell, Scell 1, | 5G (or Scell | UCIs for cells {Pcell, Scell 1, Scell 2} are inter- |
| Scell 2} | identified by cell | RAT UCIs and are carried in a 5G PUCCH, or |
| | id 3) | PUCCH supported by Scell 3. |
| {Scell 1} | 4G (or Scell | UCIs for cell {Scell 1} belongs to 5G RAT and are |
| | identified by cell | carried in a 4G PUCCH, or a PUCCH supported by |
| | id 2) | Scell 2. |
| {Scell 1} | 5G (or Pcell) | UCIs for cell {Scell 1} belongs to 4G RAT and are |
| | | carried in a 5G PUCCH, or a PUCCH supported by |
| | | Pcell. |

The configuration information may be sent from the network to the UE via a Radio Resource Control (RRC) message, a System Information message, etc. Exemplarily, the configuration information may be carried in an Information Element (IE) of the RRC message, such as a PUCCH configuration IE (PUCCH-Config IE), PUCCH configuration common IE (PUCCH-ConfigCommon IE), and the like.

The RRC message may include an RRCReconfiguration message. For example, UE may receive the RRCReconfiguration message including the configuration information when network attempts to add Scell for UE.

### Step 2:

UE sends UCIs belonging to various RATs (e.g., 3G, 4G, and 5G) or various cells (e.g., Pcell, Scell(s)) on designated PUCCH based on the configuration information received in step 1.

Based on the configuration information, the UE may determine the UCI to PUCCH mapping information.

In some example implementations, UE may determine UCIs belonging to certain cells, or belonging to certain RATs are mapped to a PUCCH supported by a particular cell or a PUCCH belonging to a particular RAT.

In some example implementations, UE may determine UCIs belonging to certain carrier(s) are mapped to a PUCCH supported by a particular carrier.

As an example, in an Inter-RAT CA deployment, the Pcell corresponds to 4G RAT, and Scell 1 corresponds to 5G RAT. Based on a received configuration information, UE may determine that UCIs belonging to 5G RAT (or UCIs belonging to Scell 1) are mapped into and carried in the PUCCH of the Pcell (note that the PUCCH belongs to 4G RAT as the Pcell does).

As another example, in an Inter-RAT CA deployment, the Pcell corresponds to 4G RAT, and Scell 1 corresponds to 5G RAT. Based on a received configuration information, UE may determine that UCIs belonging to any one of 5G RAT and 4G RAT are mapped into and carried in a 4G PUCCH; or UE may determine that UCIs belonging to any one of Pcell and Scell 1 are mapped into and carried in the PUCCH of the Pcell.

Note that the UE transmits the PUCCH following specification of the RAT to which the PUCCH belongs to.

In some example implementations, the UE may encode each UCI carried in the PUCCH based on the RAT of the each UCI (i.e., following the specification of the respective RAT).

### Embodiment 3: Cross-RAT UCI Mapping-UCI Processing

In this embodiment, UCIs belonging to one RAT may be mapped into and carried in a PUCCH belonging to a different RAT. In one implementation, a PUCCH belonging to one RAT may carry UCIs belonging to the same RAT and UCIs belonging to a different RAT. In one implementation, a PUCCH belonging to one RAT may only carry UCIs belonging to a different RAT.

When a UCI belonging to one RAT is carried in a PUCCH belonging to a different RAT, UCI processing may include, but not limited to: UCI bit sequence generation, cyclic redundancy check (CRC) calculation, channel coding, rate matching, etc. The UCI is processed according to the RAT specification corresponding to the UCI. For example, a 4G RAT UCI is processed according to its UCI RAT, which is 4G RAT.

When a UCI belonging to one RAT is carried in a PUCCH belonging to a different RAT, the PUCCH processing may include, but not limited to: sequence and cyclic shift hopping processing, PUCCH format determination, etc. The PUCCH is processed according to the RAT specification corresponding to the PUCCH. For example, for a 5G RAT PUCCH carrying both 4G RAT UCIs and 5G RAT UCIs, the PUCCH is processed according to 5G RAT specification.

In some example implementations, a PUCCH of one RAT may carry UCIs of multiple RATs, and these UCIs may be processed jointly.

The joint processing of the UCIs of multiple RATs may include following steps:
1) The bit sequences of each of the UCIs are concatenated, to obtain a concatenated bit sequence.
2) The concatenated bit sequence is processed or encoded, which may include at least one of: CRC calculation, channel coding, rate matching, etc.

In some example implementations, a PUCCH of one RAT may carry UCIs of multiple RATs, and these UCIs may be processed individually. This scheme may include following steps:
1) Each UCI's bit sequence is individually processed or encoded, which may include at least one of: CRC calculation, channel coding, rate matching, etc.
2) Map the individually processed or encoded UCI into the PUCCH.

A PUCCH of one RAT may carry UCIs of multiple RATs. When mapping these UCIs to the PUCCH, an ordering rule may be followed.

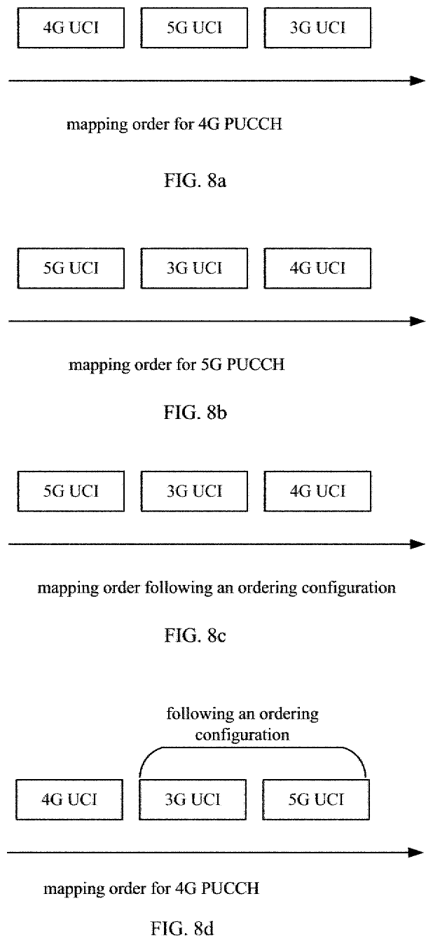

In some example implementations, the ordering rule may include: UCI belonging to a same RAT as the PUCCH is ordered before UCIs belonging to other RATs. Referring to FIG. 8a, the PUCCH is a 4G PUCCH, therefore, the 4G UCI is ordered before UCIs belonging to other RATs. Referring to FIG. 8b, the PUCCH is a 5G PUCCH, therefore the 5G UCI is ordered before UCIs belonging to other RATs.

In some example implementations, the ordering rule may include: ordering UCIs of different RATs based on an ordering configuration. The ordering configuration may be predefined, or transmitted to the UE from the network side. Referring to FIG. 8c, the ordering configuration may include: ordering the UCIs following this order: 5G, 3G, and 4G.

In some example implementations, the ordering rule may include: UCI belonging to a same RAT as the PUCCH is ordered before UCIs belonging to other RATs. Then UCIs belonging to other RATs are ordered based on an ordering configuration. The ordering configuration may be predefined, or transmitted to the UE from the network side. Referring to FIG. 8d, the PUCCH is a 4G PUCCH, so the 4G UCI is ordered before the rest of UCIs belonging to other RATs (i.e., 3G UCI and 5G UCI). Then the 3G UCI and the 5G UCI are order based on an ordering configuration which may include: ordering the UCIs following this order: 3G, then 5G.

In some example implementations, the cross-RAT UCI mapping feature may be enabled or disabled. For example, the network side may indicate to the UE whether the UE is expected to use a PUCCH of one RAT to carry UCI of other RATs for transmission. The indication may be sent via, for example, a Downlink Control Information (DCI), an RRC message, etc.

In some example implementations, the UE may report UE capability to the network side, indicating whether the UE supports the capability of transmitting UCIs of one RAT on a PUCCH of other RATs.

### Embodiment 4: Information Elements for Supporting Cross-RAT UCI Mapping

In this embodiment, UE may receive configuration information from the network (or one or more network node such as a base station within the network). The configuration information may include cross-RAT UCI mapping information indicating that UCIs for at least one RAT are mapped to and transmitted in a PUCCH of another RAT. For example, referring back to FIG. 5b, the cross-RAT UCI mapping information may indicate that 4G UCIs and 3G UCIs are mapped to and transmitted in a 5G PUCCH. Note that the cross-RAT UCI mapping information does not exclude mapping for UCIs belonging to the same RAT as the PUCCH. For example, in FIG. 5b, the cross-RAT UCI mapping information may further indicate that 5G UCIs are mapped to and transmitted in a 5G PUCCH.

In example implementations, the configuration information may be carried in one or more IE of an RRC message, such as a PUCCH configuration IE (PUCCH-Config 1E), a PUCCH configuration common IE (PUCCH-ConfigCommon IE), and the like.

Exemplarily, the RRC IEs mentioned above are PUCCH specific. One RRC IE may be used to indicate a UCI RAT for UCIs that may be mapped to and transmitted in the PUCCH that the RRC IE applies to. This RRC IE may include at least one of: an enumerated field, such as “NR”; an integer, with each value represents a RAT, such as “1” representing NR and “2” representing 4G. Another RRC IE may be used to indicate the entity from which the UCI is sent. For example, this RRC IE may indicate cell ID of a cell (such as a Pcell, a Scell, or a PScell) to which the UCI with the particular UCI RAT belongs, or to which the UCI with the particular UCI RAT applies. For another example, this RRC IE may indicate a cell group to which the UCI with the particular UCI RAT belongs, or to which the UCI with the particular UCI RAT applies

For example, the 4G RRC IE PUCCH-Config (applies to a 4G PUCCH) may include two RRC IEs. The first RRC IE is an enumerated field, and the field is set to “NR” or “5G”; the second RRC IE may include a ServCellIndex, and its value is 1. When the UE receives such configuration information, the UE may determine that the PUCCH on this 4G cell carries UCIs apply to or belong to the 5G cell with the cell index 1.

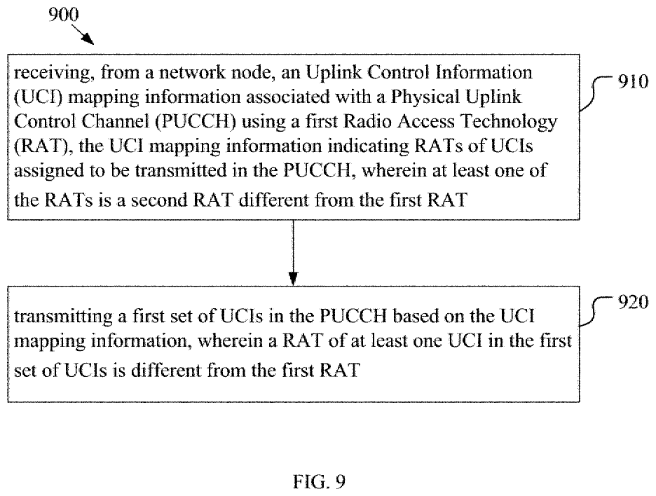

FIG. 9 shows an exemplary method 900 for wireless communication. The method may include a portion or all of the following step: step 910, receiving, from a network node, an Uplink Control Information (UCI) mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and step 920, transmitting a first set of UCIs in the PUCCH based on the UCI mapping information, wherein a RAT of at least one UCI in the first set of UCIs is different from the first RAT.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a wireless device in a wireless network, comprising:
receiving, from a network node, an Uplink Control Information (UCI) mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and
transmitting a first set of UCIs in the PUCCH based on the UCI mapping information, wherein a RAT of at least one UCI in the first set of UCIs is different from the first RAT.

2. The method of claim 1, wherein:
the UCI mapping information comprises a combination of: a target RAT, and a cell identifier corresponding to the target RAT, the target RAT being different from the first RAT; and
the UCI mapping information indicates that a UCI belonging to the target RAT for a cell identified by the cell identifier is assigned to be transmitted in the PUCCH.

3. The method of claim 1, wherein the first RAT comprises one of:
a second generation RAT comprising a Global System for Mobile Communications (GSM) RAT;
a third generation RAT comprising a Universal Mobile Telecommunications System (UMTS) RAT;
a fourth generation RAT comprising at least one of: a Long Term Evolution (LTE) RAT, or an Evolved UMTS Terrestrial Radio Access Network (E-UTRAN) RAT;
a Fifth Generation RAT comprising a New Radio (NR) RAT;
a Wi-Fi RAT;
a Bluetooth RAT; or
a ZigBee RAT.

4. The method of claim 1, wherein transmitting the first set of UCIs in the PUCCH comprises:
encoding each UCI in the first set of UCIs based on its corresponding RAT.

5. The method of claim 1, wherein the first set of UCIs is mapped to the PUCCH by:
concatenating a bit sequence of each UCI in the first set of UCIs to obtain an aggregated bit sequence;
encoding the aggregated bit sequence to obtain an encoded bit sequence; and
mapping the encoded bit sequence to the PUCCH;
or, wherein the first set of UCIs is mapped to the PUCCH by:
encoding a bit sequence of each UCI in the first set of UCIs to obtain a corresponding encoded bit sequence; and
individually mapping the encoded bit sequence corresponding to the each UCI in the first set of UCIs to the PUCCH.

6. (canceled)

7. The method of claim 1, wherein:
UCIs in the first set of UCIs are mapped to the PUCCH following an order rule;
the ordering rule is based on RATs of the UCIs in the first set of UCIs; and
the ordering rule is pre-configured or transmitted to the wireless device from the wireless network.

8. The method of claim 7, wherein the ordering rule is characterized by:
UCI with the same RAT as the first RAT being preceding UCIs with RATs different from the first RAT.

9. The method of claim 1, wherein transmitting the first set of UCIs in the PUCCH comprises:
mapping the first set of UCIs to the PUCCH following an ordering rule.

10. The method of claim 9, wherein:
the first set of UCIs comprises a first UCI with a RAT that is same as the first RAT, and a second set of UCIs with RATs different from the first RAT; and
the ordering rule is characterized by one of:
the first UCI being mapped preceding the second set of UCIs;
the UCIs in the first set of UCIs being mapped based on a first ordering configuration; or
the first UCI being mapped preceding the second set of UCIs, and UCIs in the second set of UCIs being ordered by a RAT of each UCI in the second set of UCIs based on a second ordering configuration.

11. The method of claim 1, wherein the network node comprises a base station, the base station comprising one of:
a gNodeB (gNB);
an eNodeB (eNB);
an ng-eNodeB (ng-eNB); or
a NodeB.

12. A method for wireless communication, performed by a network node in a wireless network, comprising:
transmitting, to a wireless device, an Uplink Control Information (UCI) mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and
receiving, from the wireless device, a first set of UCIs in the PUCCH based on the UCI mapping information, wherein a RAT of at least one UCI in the first set of UCIs is different from the first RAT.

13. The method of claim 12, wherein:
the UCI mapping information comprises a combination of: a target RAT, and a cell identifier corresponding to the target RAT, the target RAT being different from the first RAT; and
the UCI mapping information indicates that a UCI belonging to the target RAT for a cell identified by the cell identifier is transmitted in the PUCCH;
or, wherein the first RAT comprises one of:
a second generation RAT comprising a Global System for Mobile Communications (GSM) RAT;
a third generation RAT comprising a Universal Mobile Telecommunications System (UMTS) RAT;
a fourth generation RAT comprising at least one of: a Long Term Evolution (LTE) RAT, or an Evolved UMTS Terrestrial Radio Access Network (E-UTRAN) RAT;
a Fifth Generation RAT comprising a New Radio (NR) RAT;
a Wi-Fi RAT;
a Bluetooth RAT; or
a ZigBee RAT;
or, wherein receiving the first set of UCIs in the PUCCH comprises:
decoding each UCI in the first set of UCIs based on its corresponding RAT.

14. (canceled)

15. (canceled)

16. The method of claim 12, wherein the first set of UCIs is mapped by the wireless device to the PUCCH by:
concatenating a bit sequence of each UCI in the first set of UCIs to obtain an aggregated bit sequence;
encoding the aggregated bit sequence to obtain an encoded bit sequence; and
mapping the encoded bit sequence to the PUCCH;
or, wherein the first set of UCIs is mapped by the wireless device to the PUCCH by:
encoding a bit sequence of each UCI in the first set of UCIs to obtain a corresponding encoded bit sequence; and
individually mapping the encoded bit sequence corresponding to the each UCI in the first set of UCIs to the PUCCH.

17. (canceled)

18. The method of claim 12, wherein:
UCIs in the first set of UCIs are mapped to the PUCCH following an order rule;
the ordering rule is based on RATs of the UCIs in the first set of UCIs; and
the ordering rule is pre-configured or transmitted to the wireless device from the wireless network.

19. The method of claim 18, wherein the ordering rule is characterized by:
UCI with the same RAT as the first RAT being preceding the UCIs with RATs different from the first RAT.

20. The method of claim 12, wherein receiving the first set of UCIs in the PUCCH comprises:
receiving a bitstream corresponding to the first set of UCIs from the PUCCH; and
decoding each UCI in the first set of UCIs from the bitstream following an ordering rule, to obtain the each UCI in the first set of UCIs.

21. The method of claim 20, wherein:
the first set of UCIs comprises a first UCI with a RAT that is same as the first RAT, and a second set of UCIs with RATs different from the first RAT; and
the ordering rule is characterized by one of:
the first UCI being mapped preceding the second set of UCIs;
the UCIs in the first set of UCIs being mapped based on a first ordering configuration; or
the first UCI being mapped preceding the second set of UCIs, and UCIs in the second set of UCIs being ordered by a RAT of each UCI in the second set of UCIs based on a second ordering configuration.

22. The method of claim 12, wherein the network node comprises a base station, the base station comprising one of:
a gNodeB (gNB);
an eNodeB (eNB);
an ng-eNodeB (ng-eNB); or
a NodeB.

23. A device or network node for wireless communication comprising a memory for storing computer instructions and a processor in communication with the memory, wherein, when the processor executes the computer instructions, the processor is configured to:
receive, from a network node, an Uplink Control Information (UCI) mapping information associated with a Physical Uplink Control Channel (PUCCH) using a first Radio Access Technology (RAT), the UCI mapping information indicating RATs of UCIs assigned to be transmitted in the PUCCH, wherein at least one of the RATs is a second RAT different from the first RAT; and
transmit a first set of UCIs in the PUCCH based on the UCI mapping information, wherein a RAT of at least one UCI in the first set of UCIs is different from the first RAT.

24. A computer program product comprising a non-transitory computer-readable program medium with computer code stored thereupon, the computer code, when executed by one or more processors, causing the one or more processors to implement a method of claim 1.
